(19) United States
(12) Patent Application Publication
(10) Pub. No.: US 2016/0253038 A1
(43) Pub. Date: Sep. 1, 2016

(54) Method and System for Precise Object Control on Touch Screen Device

(71) Applicants: Albert Kao, Coatesville, PA (US); Athena Kao, Coatesville, PA (US); Jennifer Lee, Coatesville, PA (US)

(72) Inventors: Albert Kao, Coatesville, PA (US); Athena Kao, Coatesville, PA (US); Jennifer Lee, Coatesville, PA (US)

(21) Appl. No.: 14/634,810

(22) Filed: Feb. 28, 2015

(51) Int. Cl. G06F 3/041; G06F 3/0484; G06T 11/20; G06F 3/0488

(52) U.S. Cl. CPC G06F 3/0418; G06F 3/0412; G06F 3/04883; G06F 3/0484; G06T 11/20

(57) ABSTRACT

A method and system is provided to enable precise object control for performing tasks on touch-screen devices by using only a finger. Through deriving an action-point by adding a user-definable directional offset to the touch-point, the software program can display a graphic which represents a virtual tool with its functional part located at the derived action-point and its other end extending close to or under the fingertip. Visually, the spatial relation between the virtual tool and the fingertip makes the user feel the virtual tool is directly operated by the fingertip. As the virtual tool can be programmed to move along with the user's fingertip point by point, it enables the software to perform the intended task (for example, drawing a curve) as precise as the device can detect the change in the touch location of the fingertip. Furthermore, allowing the user to customize the size and orientation of the virtual tool enables greater user control and comfort.

### CROSS-REFERENCE TO RELATED APPLICATIONS

This application claims the benefit of U.S. Provisional Application No. 61/949,781, filed Mar. 7, 2014, the disclosure of which is incorporated herein by reference

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

This invention relates to touch-screen devices in general and particularly direct to a method and system that enables precise on-screen object control for performing tasks on touch-screen devices.

For touch-screen devices, such as smart phones and tablets, the most common way for the user to interact with the user interface of the device or the application software running on the device is to use a finger to touch the screen. When a fingertip touches the screen, the operation system of the device derives a single touch-point through some kind of algorithm to represent the average location of where the fingertip is touching. The operation system of the device then passes the data of the touch-point to the software with which the user is interacting. Normally, software programmed to operate on touch screen devices uses the touch-point as the “action-point” which is the point on the screen that the user intends the desired action to take place. For example, if an action-point is within a button, the software should interpret that the user's intention is to have the action (such as a click) be performed on the button, not on other user interface elements.

For software programmed for graphics design, a sequence of action-points can represent a stroke that the user intends to draw. Though intuitive and convenient, using the touch-point as the action-point has a major drawback—the action-point is covered by the fingertip, which makes it invisible to the user. Without proper visual feedback, even though a normal person can control finger movement with high precision (approximately at millimeter level), it is very difficult to move the action-point to the intended location precisely. Due to this drawback, regardless of the size of the touch-screen, it is almost impossible to perform fine work, such as drawing a perfectly closed freehand loop, by using only a fingertip without zooming in on the working area of touch-screen devices. Providing proper visual feedback is subtle, not every visual feedback can help in precise object control. It is critical to establish appropriate spatial relationship and visual connection between the action point and fingertip. An example of failed attempts comes from Microsoft. To support touch screen for its Vista operation system, Microsoft developed Virtual Mouse which was composed of an image of a mouse device and a disconnected pointer icon. Its design idea is to let the user use a finger to manipulate an on-screen virtual mouse device to emulate controlling a physical mouse device. This design works in simple tasks such as clicking or selecting an object on the screen, but offers little help in subtle tasks such as drawing a free-hand curve. There were also designs using images representing real-world tools (for example, AccuFinger from Acer Inc.) which the user could control by fingertip so as to interact with on-screen objects. However, these virtual tool designs were limited by their fixed sizes and orientations and failed to adjust for each individual user's habit and preference. A healthy person, can generally accurately and efficiently control the movement of fingertip with the coordination of the eyes. But to control a tool by the fingertip is more complicated. It is commonly accepted that the larger the tool, the harder it is to control. Furthermore, take pencil writing for example. Each individual has his/her most comfortable and effective combination of pencil holding position/orientation and eye viewing level/angle. This fact implies that allowing the user to customize the size and orientation of the virtual tool is a key factor of an effective design of a system for precise object control by fingertip on touch screen devices.

### BRIEF SUMMARY OF THE INVENTION

The present invention provides a method and system that enables precise on-screen object control for performing tasks merely with a fingertip on touch-screen devices by incorporating a virtual tool represented by a graphic that has its normal functional part located at the action-point which is derived by adding a predefined (can be defined by the user) directional offset to the touch-point while its other end extends close to or under the fingertip.

In one embodiment of the present invention, when a fingertip touches the touch-screen, a virtual pen is displayed with the tip of the pen clearly visible by the user and the other end of the pen extending close to or under the fingertip. In the subsequent movements of the fingertip on the touch-screen, the virtual pen moves along with the fingertip.

In another embodiment of the present invention, when a finger touches the touch-screen, a graphic representing a pointer is displayed with the pointing tip clearly visible by the user and the other end of the pointer extending close to or under the fingertip. In the subsequent movements of the fingertip on the touch-screen, the pointer moves along with the fingertip.

### BRIEF DESCRIPTION OF THE DRAWINGS

FIG. 1 is a block diagram flowchart representing the typical process for incorporating the present invention.

FIG. 2 is a representation of deriving the action-point from the touch-point by adding a directional offset which can be determined by the user based on where the finger touches the screen.

FIG. 3 is a representation of two cases of bad spatial relation and visual connection between the virtual tool and the fingertip.

FIG. 4 is a representation of displaying a virtual tool when the finger touches the screen.

FIG. 5 is a representation of using a fingertip to control a virtual pen to draw a curve with subtle features.

FIG. 6 is a representation of using a fingertip to control a pointer to select one circle out of a set of circles that are apart from each other only by one tenths of the width of the finger.

FIG. 7 is a representation of using a fingertip to control a virtual magnifying glass which has its action-point at the center of the circle representing the lens.

FIG. 8 is a representation of the user interface that enables the user to customize the sizes and orientations of the virtual tools to be controlled by fingertip.

### DETAILED DESCRIPTION OF THE INVENTION

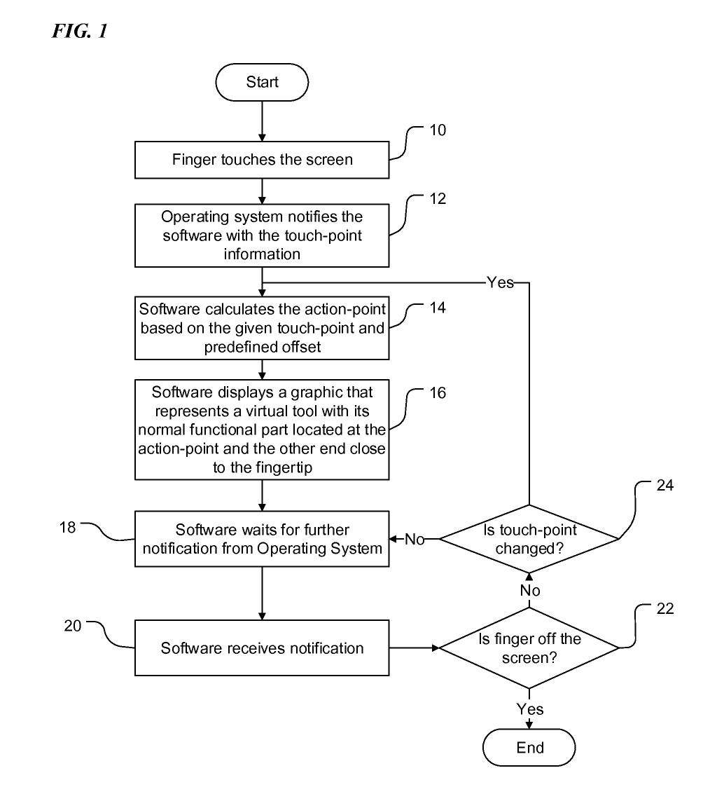

FIG. 1 and the discussion below are intended to provide a generic description of how the present invention may be implemented. The invention will be described in the general context of computer-executable instructions being executed by a computing device with a touch-screen.

With reference to block diagram flowchart of FIG. 1, a user touches the screen with a finger, as represented by block 10. In block 12, the operating system of the touch-screen device, through a certain algorithm, calculates a touch-point to represent the average location of the contact area of the fingertip and the touch-screen, and then notifies the software with which the user is interacting. Upon receiving the touch-point information, as represented in block 14, the software calculates the action-point based on the touch-point and a predefined offset. The predefined offset normally is chosen so that the action-point, if marked, can be directly viewed by the user. As the action-point is derived, in block 16, the software, depending on the intended task, displays a graphic that represents a virtual tool with its normal functional part located at the action-point and its other end extending close to or under the fingertip. At this point, the user can see as if the fingertip connects to a virtual tool. Then the software enters the stage of waiting for further notification from the operating system as represented by block 18. When the software receives notification, as represented by block 20, it needs to first determine if the notification is for the fingertip being off the screen, as represented by block 22. If the fingertip is off the screen, then the process ends. Otherwise, the process flows to block 24, which further checks if the notification is for the touch-point location being changed. The movement of the fingertip is the direct cause of the change in touch-point location. If the notification is not about change in the touch-point location, the process goes back to wait for further notification from the operating system, as represented by block 18. If the notification is for the touch-point location being changed, then the process goes to recalculate the action-point and then displays the virtual tool based on the new action-point. These sequences, in combination, create an illusion of the fingertip operating a virtual tool.

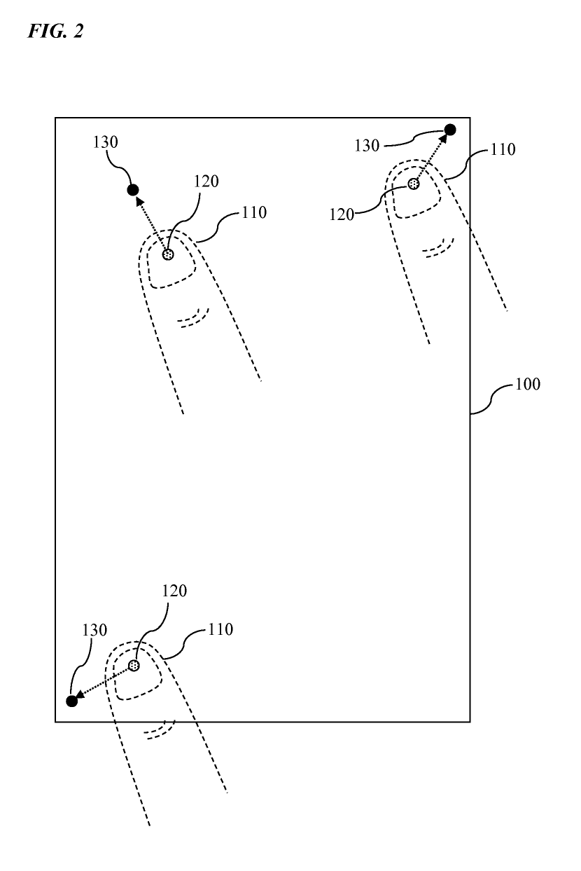

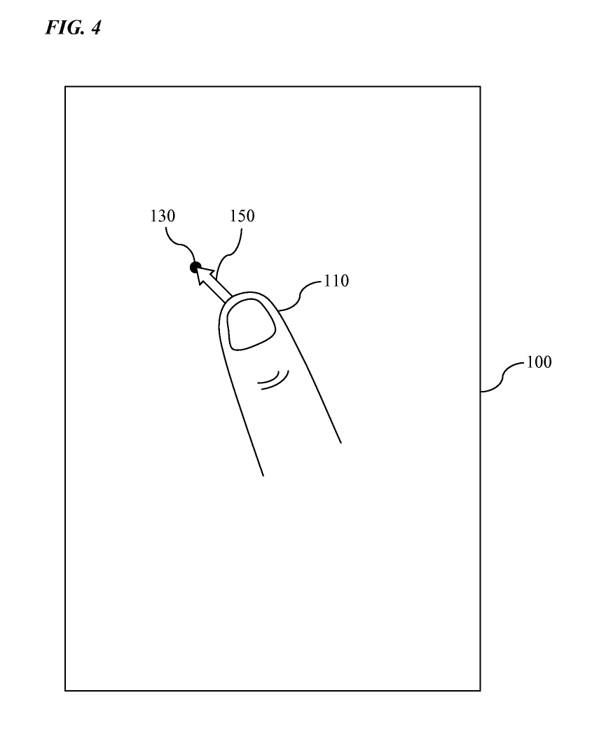

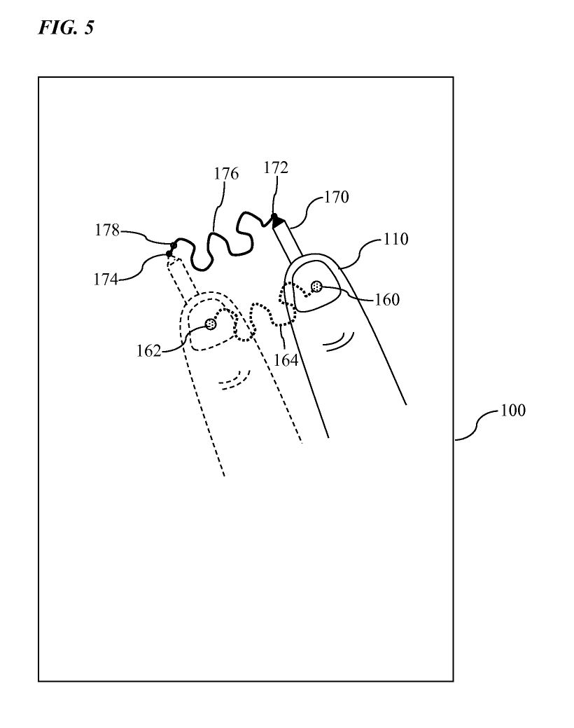

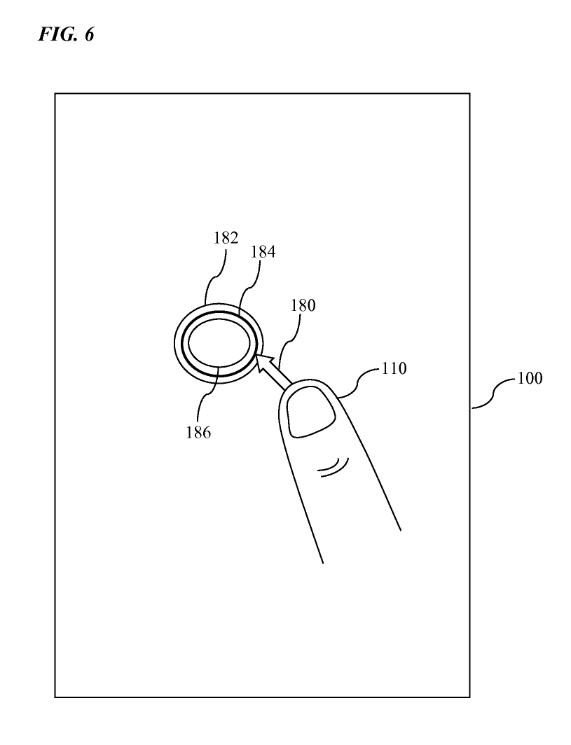

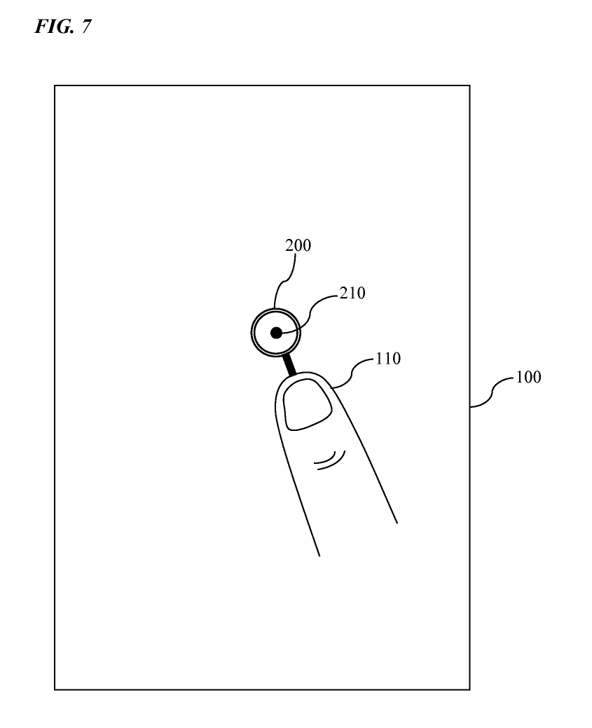

In FIG. 2, FIG. 4, FIG. 5, FIG. 6, and FIG. 7, both action-point and touch-point are represented by enlarged circles for the clarity of illustration, though they are only 1-pixel by 1-pixel in size.

With reference to FIG. 2, three illustrations of the relation among finger 110, touch-point 120, and action-point 130 are depicted on touch-screen 100. To enable the action-point to reach any point on the touch-screen, the directional offset to be added to the touch-point can be chosen by the user based on where the fingertip touches the screen. For example, if the end user wants to use the right index finger to perform tasks on the area near the bottom-left corner of the touch-screen 100, an offset pointing toward the bottom-left corner more or less can be chosen to derive the action-point from the touch-point.

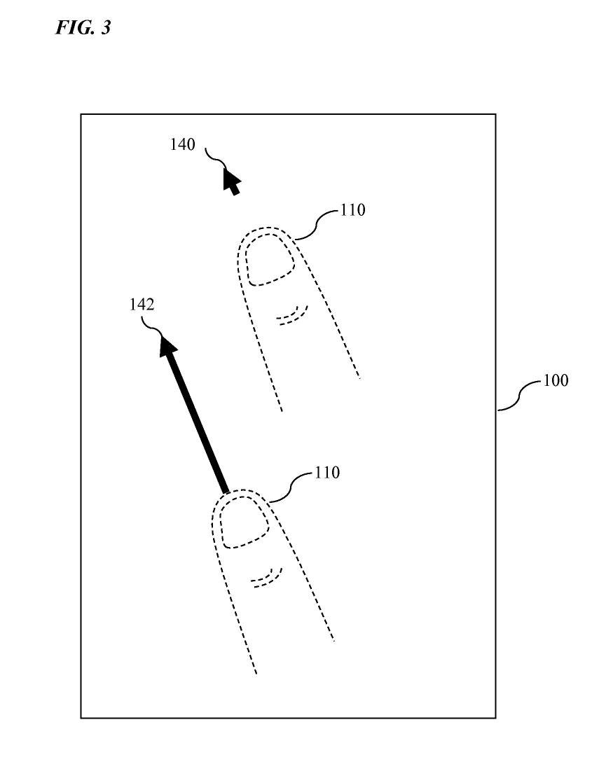

With reference to FIG. 3, the arrow-shaped graphic 140 represents any virtual tool that is visually off the fingertip 110. Due to lack of direct visual connection to the fingertip, it is hard to control the virtual tool precisely by the fingertip. Again, with reference to FIG. 3, the arrow-shaped graphic 142 represents any virtual tool whose action point is significantly distant from the fingertip 110 even though there is a visual connection between them. Based on common sense, the longer the tool, the harder it is to control.

With reference to FIG. 4, an arrow-shaped graphic 150 is displayed with its pointing tip located at the action-point 130 and its other end extending close to or under the fingertip 110. The arrow-shaped graphic 150 represents a virtual tool for pointing, which is commonly called the pointer. When the pointer is programmed to follow the movement of the fingertip, it creates a visual that makes the user feel the pointer is moved by the fingertip. A normal person can control the movement of a fingertip at millimeter precision, which implies the pointer can move at the same precision as well. Because the tip of the pointer where the action-point is located is visible to the user, the user thus can control where a task should be performed at millimeter-level precision. In general, a virtual tool can be controlled by the fingertip in two different modes—one for simply relocating the virtual tool and one for performing the task for which the virtual tool is designed. There are several well-known methods to toggle between these two modes. Tapping (quickly lifting the finger and then re-touching the screen) is the most common way for implementing toggling. In a device that supports multiple touch points, the event of a second-point touch can also be used for implementing toggling.

With reference to FIG. 5, in the graphic-design software that implements this invention, a virtual pen 170 is displayed with the pen tip located at the action-point 172 and its other end close to or under the fingertip 110. If the fingertip 110 moves on the touch-screen 100 along the wiggling path 164 starting from the touch-point 160 to the touch-point 162, the virtual pen 170 can draw the path 176 from the action-point 172 to the action-point 174. The shape of the virtual pen and its spatial relation with the fingertip gives similar visual feedback as if the user is drawing with a pen tied to the fingertip. This visual feedback is critical for controlling objects precisely. For example, given the point 174 and the point 178, without utilizing the present invention, there is no sure way to use only fingertip 110 to draw a curve passing through these two points because both points are covered by the fingertip and the user does not know the exact location of the touch-point.

With reference to FIG. 6, circle 182, circle 184, and circle 186 are non-intersecting and a distance apart from each other that is only about one tenth of the width of the fingertip 110. It is obvious that there is no sure way to select circle 184 out of the three circles if only finger touch is used because the user cannot see the touch-point. For the software implementing the present invention, a virtual pointer 180 that has its pointing tip located at the action-point and its other end extending close to or under the fingertip can be controlled easily and precisely.

Though in the forgoing description and discussion, the action-point is where the tip of the virtual tool is located, it is by no means asserting that the action-point can only be incorporated at the vertex or tip of a graphic representing a virtual tool. The action-point in general, should be incorporated at the functional part of a virtual tool; for example, the lens center of a magnifying glass or the center of the crosshairs of a telescope. To illustrate this point, with reference to FIG. 7, a virtual magnifying glass 200 whose center of lens located at action-point 210 and the end of the handle extending close to or under fingertip 110 is displayed when finger 110 touches the touch-screen 100.

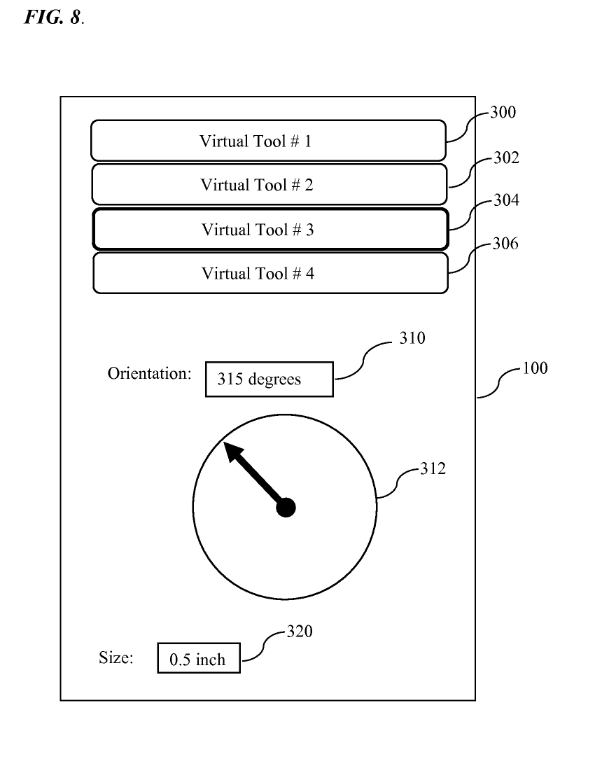

With reference to FIG. 8, the selectable element 300, element 302, element 304, and element 306 represent a collection of user interface objects that can invoke the user interface to customize the size and orientation (equivalently, a directional offset or a vector) of a virtual tool. Though there are only four elements displayed, the collection is not limited to have only four elements and in fact can have any appropriate size. Element 310 represents the user interface element that allows the user to input the orientation of the virtual tool in terms of any appropriate unit of angle. Element 320 represents the user interface element that allows the user to input the size of the virtual tool in term of any appropriate unit of length. Element 312 represents an optional graphic that helps the user visualize the effect of the inputs filled in the element 310 and the element 320. Note that, as a vector can be equivalently specified in Cartesian coordinate system which specifies horizontal and vertical components, or in Polar coordinate system which specifies the magnitude and angle, Element 310 and Element 320 can also represent the user interface elements taking the inputs for horizontal dimension and vertical dimension of the virtual tool.

While the prior detailed description of the present invention enables those skilled in the art to make and use what is considered currently the best mode thereof, it should be understood, however, there is no intention to limit the present invention to the specific embodiment, method, and examples disclosed herein. On the contrary, the present invention is limited only by all the embodiments and methods within the scope and sprit of the invention.

What is claimed is:

1. A method and system for touch-screen device, comprising:
(a) an algorithm that derives an action-point from a touch-point by adding a predefined (can be defined by the user) directional offset to the position of the touch-point;
(b) a virtual tool represented by a graphic whose normal functional part is located at the action-point while its other end extends close to or under the fingertip;
(c) a mechanism to customize the size and/or orientation of the said virtual tool.

2. The method and system of claim 1, wherein the distance between the action-point and the touch-point is equal to or less than one inch.

3. The method and system of claim 1, wherein the said mechanism to customize the size and/or orientation of the virtual tool is embodied by an user interface comprising:
(a) a selectable list of virtual tools for the user to select one to be configured;
(b) an input interface element for the user to provide the desired size of the said selected virtual tool;
(c) an input interface element of the user to provide the desired orientation of the said selected virtual tool.

4. The method and system of claim 1, wherein the said mechanism to customize the size and/or orientation of the virtual tool is embodied by a data file containing:
(a) a data item for holding the name or identifier of a virtual tool;
(b) a data item for holding desired size of the said virtual tool;
(c) a data item for holding the desired orientation of the said virtual tool.

5. The method and system of claim 3, wherein the distance between the action-point and the touch-point is equal to or less than one inch.

6. The method and system of claim 4, wherein the distance between the action-point and the touch-point is equal to or less than one inch.

7. The method and system of claim 1, wherein the said mechanism to customize the size and/or orientation of the virtual tool is embodied by an user interface comprising:
(a) a selectable list of virtual tools for the user to select one to be configured;
(b) an input interface element for the user to provide the desired horizontal offset of the said selected virtual tool;
(c) an input interface element of the user to provide the desired vertical offset of the said selected virtual tool.

8. The method and system of claim 1, wherein the said mechanism to customize the size and/or orientation of the virtual tool is embodied by a data file containing:
(a) a data item for holding the name or identifier of a virtual tool;
(b) a data item for holding desired horizontal offset of the said virtual tool;
(c) a data item for holding the desired vertical offset of the said virtual tool.

9. The method and system of claim 7, wherein the distance between the action-point and the touch-point is equal to or less than one inch.

10. The method and system of claim 8, wherein the distance between the action-point and the touch-point is equal to or less than one inch.
